(19) United States
(12) Patent Application Publication
(10) Pub. No.: US 2025/0117281 A1
(43) Pub. Date: Apr. 10, 2025

(54) IMPROVING A SYSTEM BY DETECTING FAULTY COMPONENTS

(71) Applicant: Naval Information Warfare Center Pacific, San Diego, CA (US)

(72) Inventors: Dean-Yue Lee, San Diego, CA (US); Andrew Sabater, San Diego, CA (US)

(73) Assignee: THE UNITED STATES OF AMERICA AS REPRESENTED BY THE SECRETARY OF THE NAVY, San Diego, CA (US)

(21) Appl. No.: 18/481,768

(22) Filed: Oct. 5, 2023

(51) Int. Cl. G06F 11/07; G06F 17/16

(52) U.S. Cl. CPC G06F 11/079; G06F 11/0736; G06F 17/16

(57) ABSTRACT

A method for improving a system by detecting faulty components is described herein. The method includes calculating a baseline state of a component, calculating a current state of the component, and detecting a component fault based on the time series of new observed data. Computing the baseline state of a component includes converting a time series of observed data from the component into a sequence of graphs, computing an adjacency matrix and a normalized Laplacian matrix for each graph, computing summary values for each graph, and computing the baseline state of the component. Computing the current state of the component includes converting a time series of new observed data from the component into a sequence of graphs, computing an adjacency matrix and a normalized Laplacian matrix for each graph, and computing summary values for each graph.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor. Licensing and technical inquiries may be directed to the Office of Research and Technical Applications, Naval Information Warfare Center Pacific, Code 72120, San Diego, CA, 92152; (619) 553-5118; NIWC_Pacific_T2@us.navy.mil. Reference Navy Case Number 211152.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 is an example of calculating the a baseline state for a component; and

FIG. 2 is an example of calculating a current state of a component and detecting a component fault based on the time series of new observed data.

### BACKGROUND

Modern machinery are complex systems with many sensors integrated within the system that provide diagnostics information. The interactions among the various components within a particular system may be unique to that system. Modeling component behavior via sensors integrated in a system allows for detecting abnormalities in the system to prevent a catastrophic failure of a system or determining the source of a malfunctioning system. Generally, component models may describe a hierarchy of functional components in a system, component responsibilities, component static relationships, and the way components collaborate to deliver required functionality within a given system.

### DETAILED DESCRIPTION

Modern systems rely on sensors integrated into the system to provide diagnostics information. Generalized methods are developed to model the states of individual components, such that abnormalities (e.g. faults) can be detected. Current methods are developed with the assumption that components exhibit the same behaviors across all systems, and do not account for the unique interactions among the components within a specific system. Due to this limitation, components are often removed before the end of their useful life based on expensive component failure trials or prior subject matter expert experience. Premature removal of a component or expert experience is not optimal, as faults do not occur on regular predictable timelines across all systems and thus the full value of components are not realized. Similarly, components may be used in a system after a component fault resulting in a failure of the overall system.

Moreover, with expensive components, a very limited sample size may be used to estimate failure rates, with results that are not generalized to a larger population. Not all fault types will be discovered or tested at the time of failure trials. Regular maintenance is often scheduled to inspect components to address issues related to poor estimates of failure rate or limited diagnostic capacities due to current sensor data processing methods. However, regular maintenance reduces the availability and readiness of these systems.

The method herein describes system-specific component behavior models and detects component faults or malfunctions during occurrence, thereby avoiding unnecessary maintenance inspections, premature replacements, inaccurate methods based on expert experience, or overall system failure. Furthermore, the method herein is applicable to any system component in different systems as the method accounts for the system the component is being used in by accounting for unique interactions among the components. The method herein calculates a baseline component state within the system before monitoring the system for faults, malfunctions, or failures. As a result, the method is applicable to any component in a specific system where sensors can be used to monitor the system.

A method for improving a system by detecting faulty components is described herein. The method includes calculating a baseline state of a component, calculating a current state of the component, and detecting a component fault based on the time series of new observed data. Computing the baseline state of a component includes converting a time series of observed data from the component into a sequence of graphs, computing an adjacency matrix and a normalized Laplacian matrix for each graph, computing summary values for each graph, and computing the baseline state of the component. Computing the current state of the component includes converting a time series of new observed data from the component into a sequence of graphs, computing an adjacency matrix and a normalized Laplacian matrix for each graph, and computing summary values for each graph.

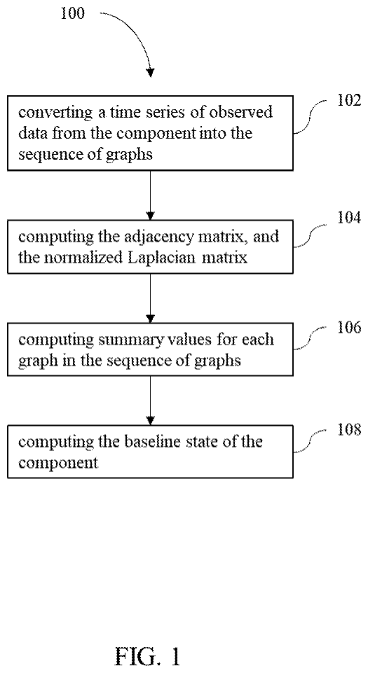

Referring now to FIG. 1, an example of calculating a baseline state of a component 100 in a system is shown. Calculating the baseline state of a component 100 includes four sub-steps. In some examples, the component may be any component with a sensor in an aircraft system, a vehicle system, or a ship system. In some examples, the component in the aircraft system, the vehicle system, or the ship system may be an aircraft component, a vehicle component, or a ship component with a sensor. The sensor is used to gather data for the calculation of the baseline state of the component.

Referring back to calculating the baseline state of the component 100, first, a time series of observed data from the component is converted into a sequence of graphs, (Gᵢ), where i is an integer that represents the index for the sequence of graphs 102. For example, Gᵢ represents each graph, G₁, G₂, G₃, etc. in the sequence of all graphs created from the time series of observed data from the component. In an example, (Gᵢ) represents one or more graphs as the sequence of graphs. A graph Gᵢ from the sequence of graphs (Gᵢ) can be represented by Gᵢ=(Vᵢ, Eᵢ) where Vᵢ are vertices for Gᵢ and Eₜ are edges for Gᵢ. In an example, the time series of observed data can be obtained from a sensor. In some examples, the sensor may be any sensor in the aircraft system, the vehicle system, or the ship system. Additionally, in an example, a computer processor and a data storage device may be used to convert and store the sensor data into a sequence of graphs.

Referring back to FIG. 1, calculating the baseline state of the component 100 includes computing an adjacency matrix, Gᵢ^{A}, and a normalized Laplacian matrix 104. [symbol] for each graph Gᵢ in the sequence of graphs, (Gᵢ). The adjacency matrix describes the global structure of each graph when calculated for that graph. The Laplacian matrix describes the local structure of each graph when calculated. Similar to 102, a computer processor and a data storage device may be used to calculate and store the adjacency matrix and the normalized Laplacian matrix for each graph.

Referring back to FIG. 1, calculating the baseline of the component 100 includes computing summary values, θ_{G}_{ᵢ}^{A} and [symbol] , for each graph Gᵢ in the sequence of graphs, (Gᵢ), 106. The summary values are calculated using the following equations (I) and (II):

$${θ}_{{G}_{i}}^{A} = {Σ}_{k = 1}^{{c}_{A}} {f}_{A} ( {λ}_{A}^{k} ) \qquad ( I )$$

$${θ}_{{G}_{i}}^{ℒ} = {Σ}_{k = 1}^{{c}_{ℒ}} {f}_{ℒ} ( {λ}_{ℒ}^{k} ) \qquad ( II )$$

In equations (I) and (II), c_{A} and [symbol] are user-selected integer values, f_{A} and [symbol] are user-defined functions, λ_{A}^{k} are the sorted eigenvalues in descending order of the adjacency matrix Gᵢ^{A}, and [symbol] are the sorted eigenvalues in ascending order of the normalized Laplacian matrix [symbol] . In an example, a computer processor and a data storage device may be used to calculate and store the summary values, θ_{G}_{ᵢ}^{A} and [symbol] .

Referring back to FIG. 1, calculating the baseline state of the component 100 includes computing the baseline state of the component, \tilde{G}, 108. The baseline state of the component, \tilde{G}, is calculated by performing the Bayesian parameter estimation of the summary values, θ_{\tilde{G}}^{A} and [symbol] from observed values (θ_{G}_{ᵢ}^{A}, [symbol] ) from Gᵢ, where i is an integer that represents the index for the sequence of graphs (Gᵢ). For example, Gᵢ represents each graph, G₁, G₂, G₃, etc. in the sequence of all graphs created from the time series of observed data from the component as previously stated herein. The Bayesian parameter estimation is determined using equation (III):

$$P ( ( {θ}_{\tilde{G}}^{A} , {θ}_{\tilde{G}}^{ℒ} ) \vert ( {θ}_{{G}_{1}}^{A} , {θ}_{{G}_{1}}^{ℒ} ) , ( {θ}_{{G}_{2}}^{A} , {θ}_{{G}_{2}}^{ℒ} ) , … ) \approx P ( ( {θ}_{\tilde{G}}^{A} , {θ}_{\tilde{G}}^{ℒ} ) ) P ( ( {θ}_{{G}_{1}}^{A} , {θ}_{{G}_{1}}^{ℒ} ) , ( {θ}_{{G}_{2}}^{A} , {θ}_{{G}_{2}}^{ℒ} ) , … \vert ( {θ}_{\tilde{G}}^{A} , {θ}_{\tilde{G}}^{ℒ} ) ) \qquad ( III )$$

where (θ_{\tilde{G}}^{A}, [symbol] ) represent the baseline parameters estimated from the sequence of graphs (Gᵢ). In an example, a computer processor and a data storage device may be used to calculate and store the baseline state of the component. The baseline state of the component is then used to detect whether the component is faulty in the system.

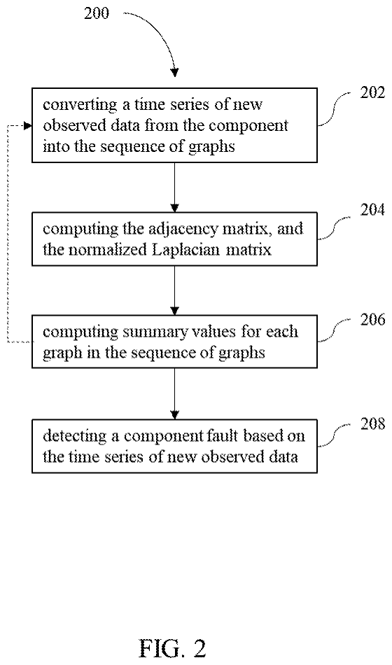

Referring now to FIG. 2, an example of calculating a current state of a component 200 in a system and detecting whether a component fault is present is shown. Calculating the current state of the component 200 includes three sub-steps. The three sub-steps are the same as previously described herein for FIG. 1, for 102, 104, and 106 when calculating a baseline state of the component 100. However, in 202 a time series of new observed data of the components current state is converted into a sequence of graphs, (Gᵢ), where i is an integer that represents the index for the sequence of graphs. The time series of new observed data is being continuously collected each time the system is used to continuously calculate the current state of the component until a component fault is detected as shown in FIG. 2 by the dashed line. Computing the adjacency matrix and the normalized Laplacian matrix 204 and computing the summary values for each graph in the sequence of graphs 206 are computed from the time series of new observed data. In an example, a computer processor and a data storage device may be used to calculate and store data for each step in 200 as well as calculate and store the current state of a component 200 in a system.

A component fault is detected based on the time series of new observed data 208. To detect a component fault, a threshold, t, is set to t>0. A component fault is detected when d ((θ_{\tilde{G}}^{A}, [symbol] ), (θ_{G}_{ᵢ}^{A}, [symbol] )≥t, where d is a distance function, for any graph in the sequence of graphs (Gᵢ) from the newly observed time series data. When d((θ_{\tilde{G}}^{A}, [symbol] ), (θ_{G}_{ᵢ}^{A}, [symbol] ))≥t, the component is determined to have a fault. In other words, the difference between the baseline state and the newly observed state of the component being monitored is determined. When that difference exceeds the threshold as described above, a component fault is detected. In an example, a computer processor and a data storage device may be used to calculate and store the threshold and distance function of each graph in the sequence of graphs (Gᵢ).

A system for detecting faulty components is also described herein. The system includes a sensor and computer processor with a storage device. The sensor records a time series of observed data and a time series of new observed data. The computer processor with the storage device obtains and stores the time series of observed data and the new time series of observed data from the sensor and calculates and stores a baseline state of a component as previously described herein for FIG. 1. The computer processor with the storage device also calculates and stores the current state of the component as previously described herein for FIG. 2. Additionally, the computer processor with the storage device detects a component fault based on the time series of new observed data as previously described herein.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 0.1 to about 20 should be interpreted to include not only the explicitly recited limits of from about 0.1 to about 20, but also to include individual values, such as 3, 7, 13.5, etc., and sub-ranges, such as from about 5 to about 15, etc.

In describing and claiming the examples disclosed herein, the singular forms “a”, “an”, and “the” include plural referents unless the context clearly dictates otherwise.

What is claimed is:

1. A method for improving a system by detecting faulty components, comprising:
calculating a baseline state of a component, wherein the baseline of a component state is determined by:
i) converting a time series of observed data from the component into a sequence of graphs (Gᵢ), where i is an integer that represents the index for the sequence of graphs;
ii) computing an adjacency matrix, Gᵢ^{A}, and a normalized Laplacian matrix, [symbol] for each graph Gᵢ in the sequence of graphs, (Gᵢ);
iii) computing summary values, θ_{G}_{ᵢ}^{A} and [symbol] for each graph Gᵢ in the sequence of graphs, (Gᵢ), with equations (I) and (II):
$${θ}_{{G}_{i}}^{A} = {Σ}_{k = 1}^{{c}_{A}} {f}_{A} ( {λ}_{A}^{k} ) \qquad ( I )$$
$${θ}_{{G}_{i}}^{ℒ} = {Σ}_{k = 1}^{{c}_{ℒ}} {f}_{ℒ} ( {λ}_{ℒ}^{k} ) \qquad ( II )$$
where c_{A} and [symbol] are user-selected integer values, f_{A} and [symbol] are user-defined functions, λ_{A}^{k} are the sorted eigenvalues in descending order of the adjacency matrix Gᵢ^{A}, and [symbol] are the sorted eigenvalues in ascending order of the normalized Laplacian matrix [symbol] and
iv) computing the baseline state of the component, \tilde{G}, by performing the Bayesian parameter estimation of the summary values, θ_{\tilde{G}}^{A} and [symbol] , from the observed values (θ_{G}_{ᵢ}^{A}, [symbol] ) from Gᵢ using equation (III):
$$P ( ( {θ}_{\tilde{G}}^{A} , {θ}_{\tilde{G}}^{ℒ} ) \vert ( {θ}_{{G}_{1}}^{A} , {θ}_{{G}_{1}}^{ℒ} ) , ( {θ}_{{G}_{2}}^{A} , {θ}_{{G}_{2}}^{ℒ} ) , … ) \approx P ( ( {θ}_{\tilde{G}}^{A} , {θ}_{\tilde{G}}^{ℒ} ) ) P ( ( {θ}_{{G}_{1}}^{A} , {θ}_{{G}_{1}}^{ℒ} ) , ( {θ}_{{G}_{2}}^{A} , {θ}_{{G}_{2}}^{ℒ} ) , … \vert ( {θ}_{\tilde{G}}^{A} , {θ}_{\tilde{G}}^{ℒ} ) ) \qquad ( III )$$
where (θ_{\tilde{G}}^{A}, [symbol] ) represent the baseline parameters estimated from the sequence of graphs;
calculating a current state of the component, wherein the current state of the component is determined by:
i) converting a time series of new observed data from the component into the sequence of graphs (Gᵢ), where i is the integer that represents the index for the sequence of graphs;
ii) computing the adjacency matrix, Gᵢ^{A}, and the normalized Laplacian matrix, [symbol] for each graph in the sequence of graphs, (Gᵢ); and
iii) computing summary values, θ_{G}_{ᵢ}^{A} and [symbol] for each graph Gᵢ in the sequence of graphs, (Gᵢ), with equations (I) and (II):
$${θ}_{{G}_{i}}^{A} = {Σ}_{k = 1}^{{c}_{A}} {f}_{A} ( {λ}_{A}^{k} ) \qquad ( I )$$
$${θ}_{{G}_{i}}^{ℒ} = {Σ}_{k = 1}^{{c}_{ℒ}} {f}_{ℒ} ( {λ}_{ℒ}^{k} ) \qquad ( II )$$
where c_{A} and [symbol] are user-selected integer values, f_{A} and [symbol] are user-defined functions, λ_{A}^{k} are the sorted eigenvalues in descending order of the adjacency matrix Gᵢ^{A}, and [symbol] are the sorted eigenvalues in ascending order of the normalized Laplacian matrix [symbol] ; and
detecting a component fault based on the time series of new observed data, wherein a threshold, t, is set to t>0, and the component fault is detected when d ((θ_{\tilde{G}}^{A}, [symbol] ), (θ_{G}_{ᵢ}^{A}, [symbol] ))≥t, where d is a distance function, for any graph in the sequence of graphs (Gᵢ).

2. The method of claim 1, wherein Gᵢ=(Vᵢ, E₁) where Vᵢ are vertices for Gᵢ and Eₜ are edges for graph Gᵢ in the sequence of graphs (Gᵢ).

3. The method of claim 1, wherein the time series of observed data and the time series of new observed data is obtained from a sensor.

4. The method of claim 1, further including repairing or replacing a component causing the component fault.

5. The method of claim 1, wherein the system is an aircraft system, a vehicle system, or a ship system and the component is an aircraft component, a vehicle component, or a ship component.

6. The method of claim 5, wherein the time series of observed data and the time series of new observed data is obtained from a sensor in the aircraft system, the vehicle system, or the ship system.

7. The method of claim 1, wherein calculating a current state of the component is performed continuously until the component fault is detected.

8. A system for detecting faulty components, comprising:
a sensor, wherein the sensor records a time series of observed data and a time series of new observed data; and
a computer processor with a storage device, wherein the computer processor obtains and stores the time series of observed data and the new time series of observed data from the sensor and calculates and stores a baseline state of a component by:
i) converting the time series of observed data from the component into a sequence of graphs (Gᵢ), where i is an integer that represents the index for the sequence of graphs;
ii) computing an adjacency matrix, Gᵢ^{A}, and a normalized Laplacian matrix, [symbol] , for each graph Gᵢ in the sequence of graphs, (Gᵢ);
iii) computing summary values, θ_{G}_{ᵢ}^{A} and [symbol] for each graph in the sequence of graphs, (Gᵢ), with equations (I) and (II):
$${θ}_{{G}_{i}}^{A} = {Σ}_{k = 1}^{{c}_{A}} {f}_{A} ( {λ}_{A}^{k} ) \qquad ( I )$$
$${θ}_{{G}_{i}}^{ℒ} = {Σ}_{k = 1}^{{c}_{ℒ}} {f}_{ℒ} ( {λ}_{ℒ}^{k} ) \qquad ( II )$$
where c_{A} and [symbol] are user-selected integer values, f_{A} and [symbol] are user-defined functions, λ_{A}^{k} are the sorted eigenvalues in descending order of the adjacency matrix Gᵢ^{A}, and [symbol] are the sorted eigenvalues in ascending order of the normalized Laplacian matrix [symbol] and
iv) computing the baseline state of the component, \tilde{G}, by performing the Bayesian parameter estimation of the summary values, θ_{\tilde{G}}^{A} and [symbol] from the observed values (θ_{G}_{ᵢ}^{A}, [symbol] ) from each Gᵢ, i=1, 2, . . . , in the sequence of graphs (Gᵢ) using equation (III):
$$P ( ( {θ}_{\tilde{G}}^{A} , {θ}_{\tilde{G}}^{ℒ} ) \vert ( {θ}_{{G}_{1}}^{A} , {θ}_{{G}_{1}}^{ℒ} ) , ( {θ}_{{G}_{2}}^{A} , {θ}_{{G}_{2}}^{ℒ} ) , … ) \approx P ( ( {θ}_{\tilde{G}}^{A} , {θ}_{\tilde{G}}^{ℒ} ) ) P ( ( {θ}_{{G}_{1}}^{A} , {θ}_{{G}_{1}}^{ℒ} ) , ( {θ}_{{G}_{2}}^{A} , {θ}_{{G}_{2}}^{ℒ} ) , … \vert ( {θ}_{\tilde{G}}^{A} , {θ}_{\tilde{G}}^{ℒ} ) ) \qquad ( III )$$
where (θ_{\tilde{G}}^{A}, [symbol] ) represent the baseline parameters estimated from the sequence of graphs; wherein the computer processor calculates and stores the current state of the component by:
i) converting the time series of new observed data from the component into the sequence of graphs (Gᵢ), where i is the integer that represents the index for the sequence of graphs;
ii) computing the adjacency matrix, Gᵢ^{A}, and the normalized Laplacian matrix, [symbol] , for each graph in the sequence of graphs, Gᵢ; and
iii) computing summary values, θ_{G}_{ᵢ}^{A} and [symbol] , for each graph in the sequence of graphs, Gᵢ, with equations (I) and (II):
$${θ}_{{G}_{i}}^{A} = {Σ}_{k = 1}^{{c}_{A}} {f}_{A} ( {λ}_{A}^{k} ) \qquad ( I )$$
$${θ}_{{G}_{i}}^{ℒ} = {Σ}_{k = 1}^{{c}_{ℒ}} {f}_{ℒ} ( {λ}_{ℒ}^{k} ) \qquad ( II )$$
where c_{A} and [symbol] are user-selected integer values, f_{A} and [symbol] are user-defined functions, λ_{A}^{k} are the sorted eigenvalues in descending order of the adjacency matrix Gᵢ^{A}, and [symbol] are the sorted eigenvalues in ascending order of the normalized Laplacian matrix [symbol] ; and
wherein the computer processor detects a component fault based on the time series of new observed data, wherein a threshold, t, is set to t>0, and the component fault is detected when d((θ_{\tilde{G}}^{A}, [symbol] ), (θ_{G}_{ᵢ}^{A}, [symbol] ))≥t, where d is a distance function, for any Gᵢ in the sequence of graphs (Gᵢ).

9. The system of claim 8, wherein Gᵢ=(Vᵢ, Eᵢ) where Vᵢ are vertices for Gᵢ and Eᵢ are edges for graphs in the sequence of graphs (Gᵢ).

10. The system of claim 8, wherein the component is an aircraft component, a vehicle component, or a ship component.

11. The system of claim 10, wherein the aircraft component, the vehicle component, or the ship component that is faulty is configured to be repaired or replaced.

12. The system of claim 8, wherein the sensor is an aircraft sensor, a vehicle sensor, or a ship sensor.

13. The system of claim 8, wherein the computer processor is continuously calculating the current state of the component until the component fault is detected.
